(19) United States
(12) Patent Application Publication
(10) Pub. No.: US 2007/0067546 A1
(43) Pub. Date: Mar. 22, 2007

(54) ON-HOLD MESSAGE SYSTEM WITH FLASH MEMORY DRIVE

(76) Inventor: Michael D. Smith, Lincoln Park, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/462,841

(22) Filed: Aug. 7, 2006

Related U.S. Application Data
(60) Provisional application No. 60/717,173, filed on Sep. 15, 2005.

(51) Int. Cl. G06F 13/20; H04M 1/00; H04M 9/00

(52) U.S. Cl. 710/313; 379/393

(57) ABSTRACT

On-hold audio messages to be played to callers to a business telephone system who are waiting to be connected to a desired party are transmitted over the Internet to a plurality of computers at separated locations. The on-hold messages are downloaded into USB drives at each of the second computers and the USB drive is then loaded into the USB port of a digital message unit. A microprocessor in the digital message unit interrogates the files to determine the file structure and creates a file directory in the microprocessor. Operator controls allow the selection of a particular file which is loaded from the USB drive into the digital message unit where it is decompressed and converted into analog form to provide the output to the on-hold input of a business telephone system.

### RELATED APPLICATION

This application claims priority of U.S. Provisional Patent Application Ser. No. 60/717,173 filed Sep. 15, 2005, which is incorporated herein by reference.

### FIELD OF THE INVENTION

This invention relates to a system for generating on-hold audio messages for provision to business telephone systems to enable the messages to be delivered to callers who are waiting for connection to their desired party, and more particularly to such a system employing a USB-type drive to store the messages and repetitively replay them.

### BACKGROUND OF THE INVENTION

Telephone calls to business numbers having a plurality of lines often require that the caller must be placed on hold while waiting to be connected to the person who can answer the call. Rather than requiring these calling parties to hold in silence, it is conventional to play some form of audio message to encourage the callers to remain on hold. This message may be an advertisement for the business, music, news, or some combination of these audio messages. Most modern business telephone systems incorporate an input for audio signals that can be used to generate the on-hold messages.

A variety of players have been developed to provide a suitable output to the on-hold input of such telephone systems. U.S. Pat. No. 5,870,461 discloses a system wherein the audio file is stored in digital form on a compact disk. A player for the disk is provided to generate an output suitable for introduction into the on-hold input of a conventional business telephone system. The CD player must be operated continuously in order to repeat the message.

My U.S. Patent Application Publication No. 2003/0043979 discloses a system in which the audio on-hold message is stored on a floppy disk. The floppy disk is introduced into a system which incorporates a flash memory which continually repeats the message.

Both of these systems are relatively complex and thus costly and difficult to maintain.

### SUMMARY OF THE INVENTION

The present invention is accordingly directed toward a simplified form of digital message system which is relatively low in cost and highly reliable in operation. The system of the present invention uses a flash memory in the form of a USB drive to both provide a file to a digital message system which is connected to the on-hold terminal of an input of a business telephone system, and to repeatedly play the message.

The USB drive simply constitutes a flash memory of a desired capacity, such as, by way of example, 128 MB. The drive has a USB connector which allows it to be plugged into the USB port of a personal computer or of the digital message player of the present invention. No independent battery power is required. The device to which it is connected sends memory address signals to the drive and the drive simply outputs the digital values stored at those addresses. The USB drive is accordingly very small in configuration and often takes the form of a small rectangular package with the connector extending from one end. USB drives are commonly used to store digitized data representing audio or video content.

The present invention provides a system which allows on-hold messages to be distributed to a number of business telephone systems at separate geographic locations, such as franchises, chain stores and the like, by transmitting the desired audio file as an e-mail message over the Internet. A personal computer at each location then receives the e-mail. When a USB drive is inserted into the USB port of such a personal computer, the computer may recognize it as a removable drive. The audio files in the attachment to the e-mail message may be then dragged and dropped into the USB drive.

The USB drive may then be removed from the computer and inserted into a USB port of a digital message player formed in accordance with the present invention which is specially equipped to read files found on a USB drive. The system includes a digital decompressor for the files, which are usually in MP3 form or other form of compression, and a digital-to-analog converter to convert the resulting decompressed digital signal files into analog form. The resulting analog audio signals may then be connected to the on-hold input of the associated business telephone system.

The standard USB software writes a number of files on a drive. The header of each file includes the name of the file.

The player of the present invention is capable of examining the files on an inserted USB drive and creating and storing a directory of the files in memory. This directory is used for selecting an individual message to repetitively play from the contents of the USB drive. The system can adjust the volume, contour the sound with an equalizer, and includes an LCD panel which displays system settings and levels as well as the current message playing.

Accordingly, the present invention provides a user-friendly system for providing customized on-hold messages to any number of users and for individually adjusting the play at a particular telephone system.

By eliminating the need for continuously operating an optical disk player or the provision of a recirculating memory on the digital message system, characteristics of the prior art, the present invention provides a unit that is much more simple and reliable than prior art systems.

### BRIEF DESCRIPTION OF THE DRAWINGS

Other objects, advantages and applications of the present invention will be made apparent by the following detailed description of a preferred embodiment of the invention. The description makes reference to the accompanying drawings in which:

FIG. 1 is a schematic diagram illustrating the system for loading files containing on-hold messages into a USB drive;

FIG. 2 is a perspective view of the front of a digital message unit adapted to receive a USB drive containing on-hold files and to process the file to generate analog signals for provision to the on-hold input of a business telephone system;

FIG. 3 is a view of the rear of the digital message player; and

FIG. 4 is a schematic diagram illustrating the internal organization of the digital message unit of FIG. 2 and showing its output connected to the on-hold input of a business telephone system.

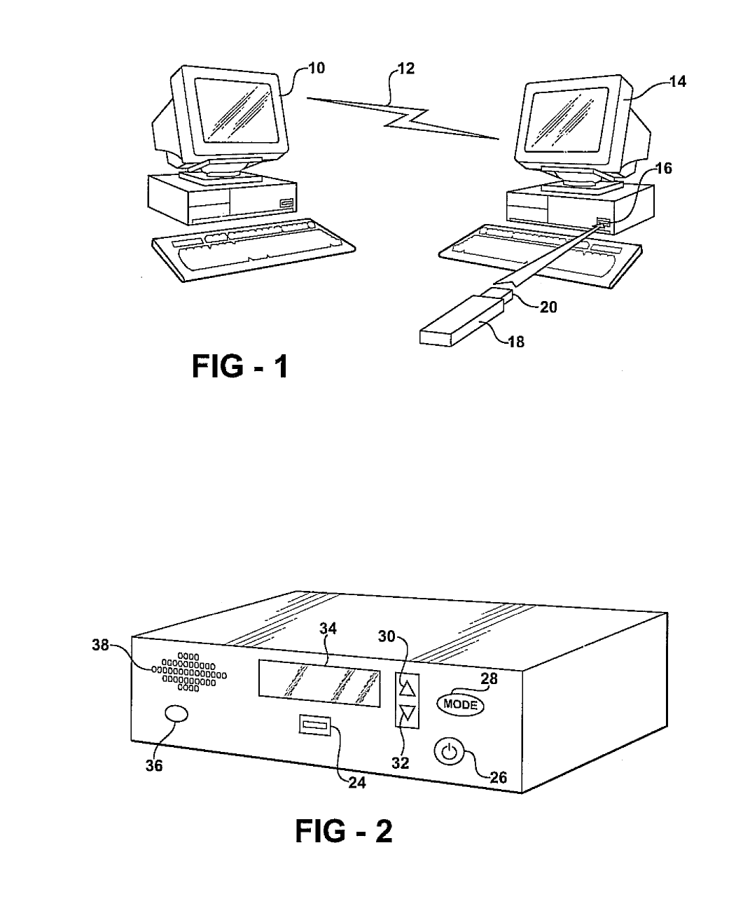

### DETAILED DESCRIPTION OF THE PREFERRED EMBODIMENT

One or more audio files intended for use as on-hold messages or the like are prepared in a compressed digital form in a computer 10 and transmitted over a suitable network 12, which may constitute the Internet, to one or more local computers 14. A computer 14 will include a USB port 16.

A USB drive 18 having a USB connector 20 may be inserted into the USB connector 16 of the computer 14. The drive 18 contains a flash memory which may be of any desired capacity. For example, the flash memory may be 128 MB. Each loaded file will have a header including the file name.

A digital file received by the computer 14 from the computer 10 may be loaded into the USB drive by plugging the male connector 20 of the drive into the USB port 16. The operator of the computer 14 then clicks on the file and drags and drops it into the USB drive 18.

A USB drive 18 loaded with a compressed digital audio file will then be connected to a digital message system generally indicated at 20. A digital message system 22 includes a USB port 24. The USB drive 18, loaded with compressed digital audio signals, may then be loaded into the digital message system 22 by inserting the male connector 20 of the USB drive 18 into the USB port 24.

The digital message system 22 includes a plurality of controls on its front panel. The power to the unit is controlled by an on-off button 26. A mode control button 28 is used in connection with a pair of up-and-down switches 30 and 32 to place the system in one of a group of selected modes. The selected mode is displayed on an LCD panel 34 on the front of the unit 22. The default mode is volume. By pressing the buttons 30 or 32 the volume may be increased or decreased. A second mode is treble adjustment, and a third mode is bass adjustment. A fourth mode is “enable all” which may be turned on or off using the buttons 30 and 32. When “enable all” is on, all of the files stored in the USB drive 18 are sequentially played by the unit. Alternatively, the mode control button 28 may be used to place the mode in “edit list”. In that case the buttons 30 and 32 are used to scroll through all of the files stored on the USB drive IS and to select one of them for play. A preview button 36 energizes or de-energizes the play of the selected file by the digital message system 22 itself through a speaker port 38 on the front of the unit.

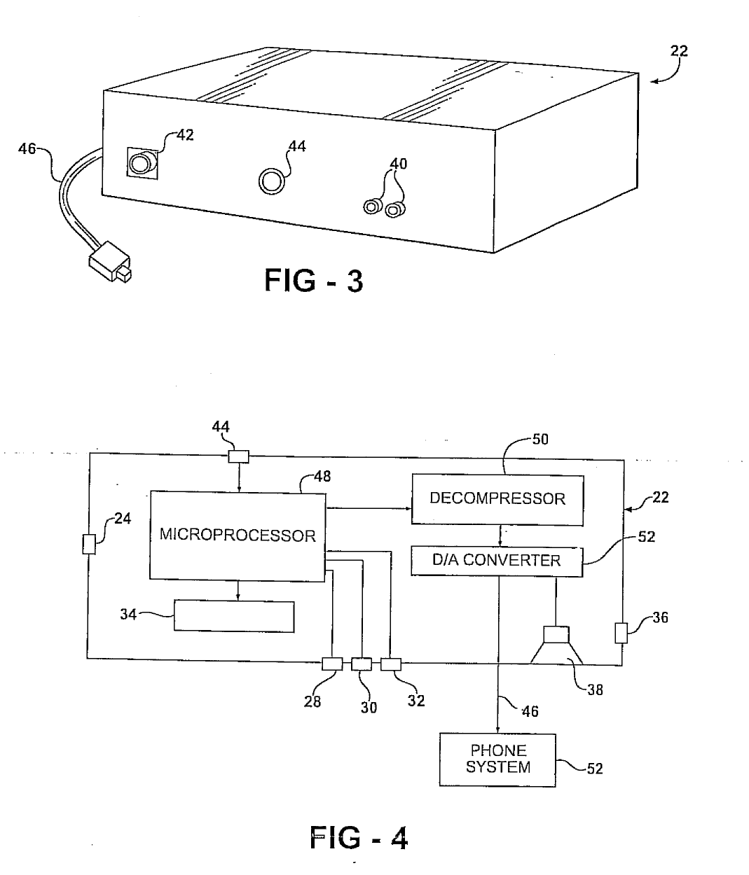

The rear of the unit 22, illustrated in FIG. 3, includes a pair of audio output connectors 40 and a power input connector 42. In the preferred embodiment of the unit, the power is 9 volts DC and is typically supplied by a converter (not shown) connected to a 115 volt AC power plug.

The rear of the unit also includes a trigger input port 44 which allows the unit to play the selected file and provide it to the audio output connectors 40, as long as the triggering input is energized. The triggering signal can come from some sensor such as a floor pressure mat. This mode of operation may be used in museums, businesses or the like when an audio message is to be delivered by the speaker port 38 or through a speaker system connected to the ports 40.

A schematic of the organization of the digital message system 22 is illustrated in FIG. 4. The operation of the system is controlled by a microprocessor 48 which receives inputs from the mode selection buttons 28, 30 and 32 and the trigger input 44. The output of the microprocessor is provided to a decompressor which converts the format of the compressed signal into a normal digital signal. The signal is normally encoded in MP3 form or other form of compression. The output of the decompressor 50 is provided to a digital-to-analog converter 52 which drives the output on line 46 to the on-hold input of a conventional business telephone system 52 as well as the output of the digital message system on the speaker 38.

The microprocessor generates address signals to the USB drive through the port 24 which select a chosen file for playing or plays all the files sequentially. A chosen file or files are played in a repetitive manner for generation of the appropriate address signals. The digital signals at the addresses are outputted on a channel by the microprocessor first to the compressor and then the compressor 15 into the digital-to-analog converter 32 to generate the appropriate output signals for the system.

The USB drive, in addition to containing a number of compressed files, contains a directory which includes the file name, the size of the file and the memory address of the starting block of the file. The microprocessor 48 interrogates the USB drive and stores this directory information in its temporary memory, preferably E-PROM. This information is used to control the downloading of the sequential blocks of information that constitute the file into the digital memory unit 22 for processing. When the unit calls for the play of a particular file, the memory address of the beginning of the file is addressed at a block of a predetermined length, preferably 1024 bytes. This block is fed into the microprocessor 48 from the USB drive and in a streaming fashion is first decompressed, converted into analog form, and provided as an output, either to the phone system 52 or the speaker 38, or both. When one block is completed another block is called for, and this process is repeated until an entire file has been processed. Depending upon the mode called for by the system, the next file may be similarly processed or the initial file may be reprocessed in the same fashion.

The file directory which has been established in the E-PROM of the microprocessor 48 is used to verify that the USB drive loaded into the system is the same one from which the file was created. If identity is not established, a new file directory is created within the microprocessor for the new drive.

Having thus described my invention, I claim:

1. A system for providing an on-hold message to a business telephone system having an on-hold input, comprising:
a USB drive loaded with at least one audio file representing a desired on-hold message, in digital compressed form;
a digital message unit having a USB port adapted to receive the USB drive loaded with the audio file, a decompressor, a digital-analog converter and a microprocessor control operative to download said audio file stored in the USB drive to the digital message system and to decompress the file and convert it into analog form to provide the output to the on-hold input of a business telephone system.

2. The system of claim 1 in which the microprocessor sends signals to the USB drive to determine the file configuration contained within the drive and to download particular files to the digital message system.

3. The system of claim 2 in which the files in the USB drive are in MP3 compressed form.

4. The system of claim 1 in which the digital message unit includes controls for programming the message unit to either play any one of the files stored on the USB drive plugged into the digital message unit or play all of the digital files in repetitive sequence.

5. The system of claim 4 wherein the digital message unit includes a display controlled by the microprocessor, providing an indication of the status of the digital memory unit.

6. The system of claim 1 wherein the microprocessor is operative to establish an internal file based on a file directory contained in a USB drive plugged into the digital memory unit.

7. The system of claim 6 wherein the file directory created by the digital message system is used to verify the identity of the files contained on a digital memory unit.

8. A digital message unit adapted to provide an on-hold message to a business telephone system having an on-hold input, comprising:
a port for receiving a USB drive loaded with at least one audio file representing a desired on-hold message, in digital compressed form;
a decompressor;
a digital-analog converter; and
a microprocessor control operative to hold an audio file stored in the USB drive to the digital message unit, to select a subfile within the file to be played, to decompress the file, and to convert it in analog form and provide the output to the on-hold input of a business telephone system.

9. The digital message unit of claim 8 wherein the microprocessor is operative to send signals to a USB drive plugged into its USB port operative to determine the file structure contained within the USB drive and to create a directory of the file structure in the digital message unit.

10. The digital message unit of claim 9 wherein the directory of the file structure of the USB drive created within a digital message unit is used to select files from the USB drive to be played repetitively by the telephone system.

11. The digital message unit of claim 9 in which the directory of the file structure of the USB drive created in the digital message unit is used to verify an identity of a USB drive inserted into the USB drive port.

12. The USB drive of claim 8 further including a display controlled by the microprocessor and selector switches for use by an operator using the information contained on the display, for selecting a file stored in a USB unit inserted into the digital message unit for repetitive play to the on-hold system.

13. The digital message unit of claim 8 further including a loudspeaker connected to the output of the digital-analog converter, operative to play audio selections downloaded from a USB drive inserted into the USB port and decompressed and converted to analog form by the digital message unit.

14. The digital message unit of claim 12 in which the operator controls include a pair of pushbuttons for use in scrolling files set forth on said display.

15. A system for providing an on-hold message to a business telephone system having an on-hold input, comprising:
a USB drive loaded with a plurality of audio files representing desired on-hold messages, in compressed digital form;
a digital message unit having a USB port adapted to receive a USB drive loaded with the audio files, the digital message unit comprising a decompressor, a digital-analog converter, and a microprocessor control operative to generate signals to a USB drive disposed in the USB port to determine the files contained in said USB drive and to create a file directory in the microprocessor, and to decompress a selected file and convert it into analog form to provide the output to the on-hold input of a business telephone system.

16. A system for providing an on-hold message to a business telephone system having an on-hold input comprising:
a first computer storing an audio file containing said on-hold message;
a second computer having a USB port;
a public network connecting the first computer to the second computer so as to transmit the on-hold message on the first computer to the second computer;
controls on the second computer for downloading the audio file containing the on-hold message into a USB drive; and
a digital message unit having a USB port adapted to receive the USB drive loaded with the audio file, the digital message unit comprising a decompressor, a digital-analog converter and a microprocessor control operative to download the audio file stored in the USB drive to the digital message system and to decompress the file and convert it into analog form to provide the output to the on-hold input of a business telephone system.

17. A system for providing an automated repeating audio message to an analog audio output, comprising:
a USB drive, said drive programmed with at least one audio file representing a desired audio message in digital compressed form;
a digital message unit having a USB port adapted to interface to said USB drive;
a decompressor connected to receive said audio file;
a digital-to-analog converter connected to receive the decompressed file to generate an audio output signal; and
a microprocessor control executing a program algorithm operative to repeatedly download said audio file stored in said USB drive to said decompressor to provide an analog audio output substantially representing said automated repeating audio message.
